(19) United States
(12) Patent Application Publication
(10) Pub. No.: US 2023/0297340 A1
(43) Pub. Date: Sep. 21, 2023

(54) SPIN-OPTRONIC TRUE RANDOM NUMBER GENERATOR

(71) Applicant: International Business Machines Corporation, Armonk, NY (US)

(72) Inventors: Julien Frougier, Albany, NY (US); Ruilong Xie, Niskayuna, NY (US); Kangguo Cheng, Schenectady, NY (US); CHANRO PARK, CLIFTON PARK, NY (US)

(21) Appl. No.: 17/700,466

(22) Filed: Mar. 21, 2022

(51) Int. Cl. G06F 7/58; G06N 10/40; G06F 9/38

(52) U.S. Cl. CPC G06F 7/588; G06N 10/40; G06F 9/3877

(57) ABSTRACT

A system includes an emitter unit that generates random numbers encoded in light polarization, and a detector unit positioned with respect to the emitter. The detector receives the random numbers from the emitter and converts them into an electrical signal. The emitter unit can include a substrate; a bottom electrically conductive and optically reflective layer outward of the substrate; an active medium layer, outward of the bottom layer, configured to convert spin information carried by injected spin-polarized electrical carriers into light polarization information carried by light emitted from radiative recombination of the electrical carriers; a top electrically conductive and optically reflective layer outward of the active medium layer; a bottom electrically conductive contact electrically interconnected with the bottom layer; a top electrically conductive contact electrically interconnected with the top layer; and an electrically conductive carrier spin-polarizer layer located between, and electrically interconnected with, the bottom layer and the bottom contact.

### BACKGROUND

The present invention relates generally to the electrical, electronic and computer arts and, more particularly, to true random number generators.

True random numbers generators (TRNGs) are specialized devices playing an important role in science and technology. TRNGs are used in a wide variety of applications: digital data processing in computers, mobile devices, ATM machines, radar systems, cryptography (encryption codes, digital keys for communication, hardware-based security), statistical sampling (nuclear medicine, finance, computer graphics), advanced simulations, and the like.

There are two main approaches to the generation of random numbers: (i) software-based random number generators, which generate high-speed pseudorandom numbers utilizing deterministic algorithms, but are vulnerable when such pseudorandom numbers are used as the keys to encryption systems, and (ii) physics-based random number generators, which generate physical random numbers by means of the inherently random or unpredictable processes in the physical world. The latter, while challenging to achieve, are generally believed to provide the best approach.

One example of a physics-based TRNG is the optical-based TRNG. Most of the proposed implementations of optical-based TRNGs use free-space cavity setups and suffer from limitations due to their size, which significantly limits their practical use. Indeed, current optical-based TRNGs suffer from large size, making it difficult to integrate them into more complex systems, as well as high cost. With regard to this latter aspect, the cost of each component is considerable and the scalability is significantly limited.

### BRIEF SUMMARY

Principles of the invention provide techniques for a spin-optronic TRNG. In one aspect, an exemplary system includes an emitter unit that generates random numbers encoded in light polarization, and a detector unit positioned with respect to the emitter unit. The detector unit receives the random numbers encoded in light polarization from the emitter unit and converts the random numbers encoded in light polarization into an electrical signal.

In another aspect, an exemplary apparatus (e.g., suitable for use as the emitter), includes a substrate; a bottom electrically conductive and optically reflective layer outward of the substrate; and an active medium layer, outward of the bottom electrically conductive and optically reflective layer, configured to convert spin information carried by injected spin-polarized electrical carriers into light polarization information carried by light emitted from radiative recombination of the electrical carriers. Also included are a top electrically conductive and optically reflective layer outward of the active medium layer; a bottom electrically conductive contact electrically interconnected with the bottom electrically conductive and optically reflective layer; a top electrically conductive contact electrically interconnected with the top electrically conductive and optically reflective layer; and an electrically conductive carrier spin-polarizer layer located between, and electrically interconnected with, the bottom electrically conductive and optically reflective layer and the bottom electrically conductive contact.

In still another aspect, an exemplary method includes forming a vertical cavity surface emitting laser (VCSEL) epitaxy stack. The epitaxy stack includes a substrate; a bottom electrically conductive and optically reflective layer outward of the substrate; an active medium layer, outward of the bottom electrically conductive and optically reflective layer, configured to convert spin information carried by injected spin-polarized electrical carriers into light polarization information carried by light emitted from radiative recombination of the electrical carriers; and a top electrically conductive and optically reflective layer outward of the active medium layer. Further steps include forming a vertical cavity surface emitting laser (VCSEL) mesa in the top electrically conductive and optically reflective layer, the active medium layer, and a portion of the bottom electrically conductive and optically reflective layer; and forming a dielectric spacer defining a spin-polarizer region on the bottom electrically conductive and optically reflective layer. The spin-polarizer region is located adjacent the mesa when viewed in plan. Even further steps include forming an electrically conductive carrier spin-polarizer layer in the spin-polarizer region and forming a bottom electrically conductive contact, electrically interconnected with the bottom electrically conductive and optically reflective layer. The bottom electrically conductive contact is located adjacent the mesa when viewed in plan. Yet a further step includes forming a top electrically conductive contact electrically interconnected with the top electrically conductive and optically reflective layer.

As used herein, “facilitating” an action includes performing the action, making the action easier, helping to carry the action out, or causing the action to be performed. Thus, by way of example and not limitation, instructions executing on a processor might facilitate an action carried out by semiconductor fabrication equipment, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
concept for a new class of TRNGs based on electrically spin-injected monolithic semiconductor laser with vertical architecture;
true random number generation rooted in stochastic physical mechanism (a truly unpredictable process);
simple, compact, energy efficient, and cheap device compared to other proposed optical-based TRNGs

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1A shows exemplary physical principles of quantum wells employed in one or more embodiments;

FIG. 1B shows aspects of operation of a vertical cavity surface emitting laser (VCSEL) of a spin-optronic true random number generator (TRNG), according to an aspect of the invention;

FIG. 2 shows a system block diagram of a spin-optronic TRNG, according to an aspect of the invention;

FIG. 3 shows a top view of a VCSEL of a spin-optronic TRNG, according to an aspect of the invention;

FIG. 4 shows a side view of the VCSEL of FIG. 3, according to an aspect of the invention;

FIGS. 5-13 show exemplary fabrication steps for the VCSEL of FIGS. 3 and 4, according to an aspect of the invention;

FIG. 14 shows a more detailed top view similar to FIG. 3, according to an aspect of the invention;

FIG. 15 shows a system schematic of a spin-optronic TRNG, with an emitter and detector collocated on the same substrate, according to an aspect of the invention;

FIG. 16 shows a system schematic of a spin-optronic TRNG, with an emitter and detector located on different substrates, according to an aspect of the invention; and

FIG. 17 shows a system schematic of a vertically integrated spin-optronic TRNG, according to an aspect of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

One or more embodiments provide a new class of TRNG based on an electrically spin-injected monolithic semiconductor optoelectronic device with a vertical architecture. In such spin-optoelectronic devices, the spin information of the injected electrons can be converted into circular polarization information carried by the emitted photons. This information transfer occurs through the optical quantum selection rules for dipole radiation associated with the conservation of angular momentum z-projections (m_{z}). This mechanism can be effectively harnessed in a confined strained active medium such as Quantum Wells (QWs) or Quantum Dots (QDs). The result is an emission of right- or left-circularly polarized photons dependent on the spin-orientation of the injected electrons. Even though Spin-LEDs are theoretically viable candidates for such spin-optronic TRNG applications, Spin-LASERs are better suited since they offer higher performance in terms of emission coherence (spatially and temporally), higher output Degree of Circular Polarization (DoCP), as well as opportunities for above room temperature operation. Moreover, the amplification effects induced by the combination of a gain medium and a resonant optical cavity provide the unique opportunity to maximize the conversion efficiency of the spin-information carried by injected carriers into light polarization information. Hence, an output DoCP close to 100% can be achieved even by injection of an imperfectly spin-polarized current in the active medium of the laser (for example a current with an effective spin-polarization between 20% and 50%). In one embodiment, injected electrons can be spin-polarized before reaching the active medium of the semiconductor laser by inserting a conductive ferromagnetic spin-injector (spin-polarizer) in one of the contact regions, preferentially close to the active medium.

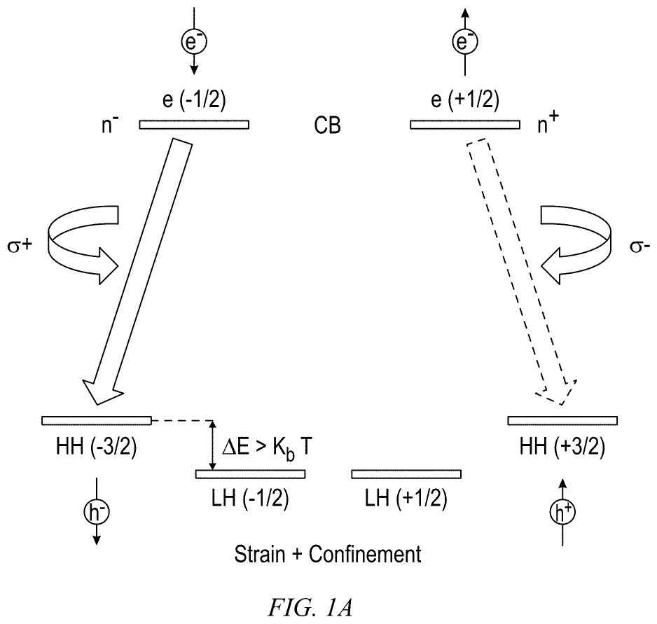

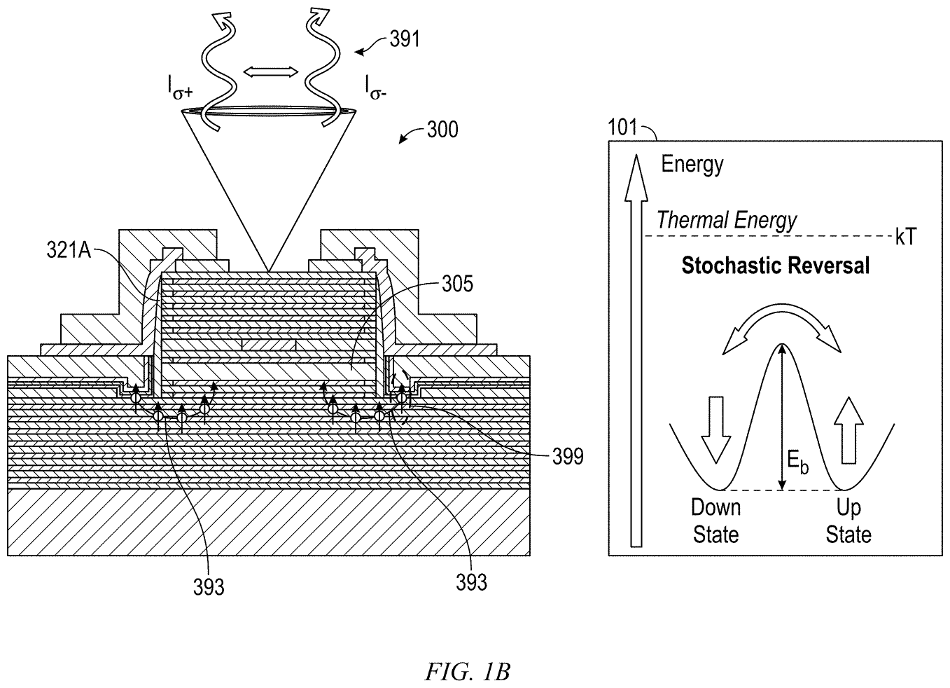

Referring to FIG. 1A, in one or more embodiments, the ferromagnetic spin-injector is specifically designed with a small energy barrier (Eb) compared to the ambient thermal energy (kT) such that Eb<<kT, where k is Boltzmann's constant (also referred to as kb), T is the absolute temperature, and kT is the ambient thermal energy. In one or more embodiments, the stochastic oscillations of the ferromagnetic spin-injector magnetization between UP and DOWN states are triggered by random fluctuations in the ambient thermal energy. The stochastic magnetization reversal of the spin-injector naturally leads to stochastic spin-polarization oscillations of the spin-injected current. In turn, stochastic polarization oscillations of the emitted photons from 100% σ+ (i.e., right circularly polarized light) to 100% σ− (i.e., left circularly polarized light) are correlated to the stochastic oscillations of the magnetization orientation of the ferromagnetic spin-injector. In Quantum Wells, the epitaxial strain and quantum confinement lift the degeneracy between the Heavy Hole (HH) band and the Light Hole (LH) band. The HH-band and the LH-band can be separated by an energy, ΔE, equal to several times the thermal energy kT. Hence, the energetically favored transition becomes Conduction Band (CB) to Heavy Hole (HH) band.

Further regarding the ambient thermal energy, one or more embodiments can be designed to be in the range of 5%-25% of the value of the ambient thermal energy kT, although the range should not be limited to that (for example, other embodiments could be 40% of kT, 50% of kT). By way of an example value, at room temperature (T=298K), kT=25.7 meV. In that case the Eb of the spin-injector could be Eb=2.57 meV (10% of kT).

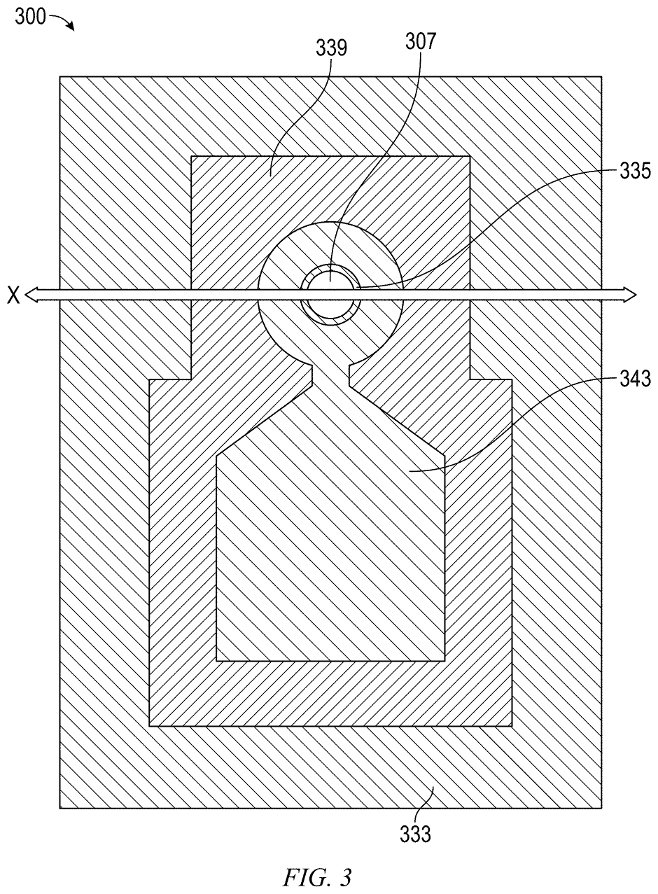

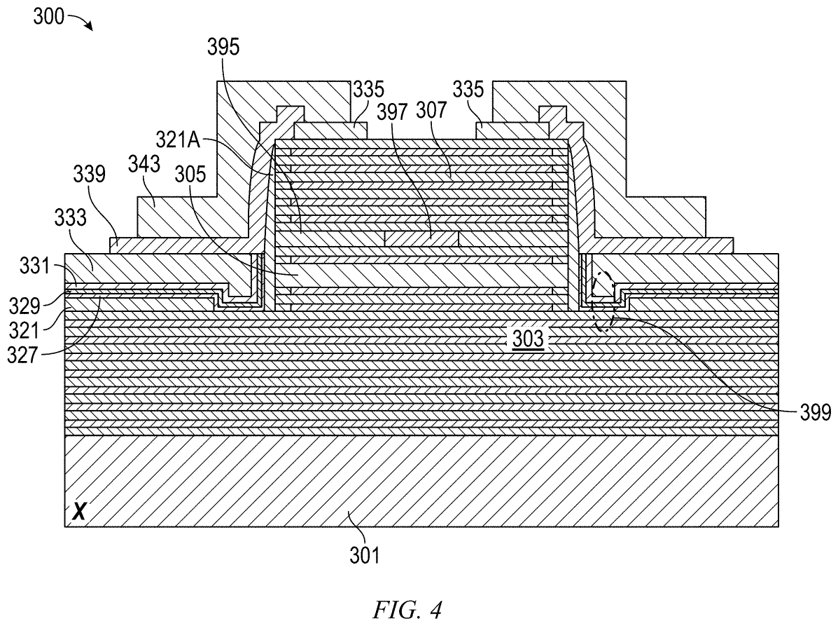

FIG. 3 is a top plan view of a monolithic spin-VCSEL (Vertical Cavity Surface Emitting Laser) device 300, to support an exemplary TRNG concept, according to aspects of the invention. Note the section line X. FIG. 4 is a side sectional view of the monolithic spin-VCSEL 300 of FIG. 3 taken along the section line X of FIG. 3. The VCSEL includes substrate 301, electrically conductive N-type bottom Distributed Bragg Reflector (DBR) 303, radiative active medium 305 including multiple quantum wells (QWs) or quantum dots (QD), aperture 397 defined by oxide 395, and electrically conductive P-type top DBR 307. The VCSEL further includes top contacts 335 and top contact pads 343 as well as bottom contacts 333 and dielectric contact isolation 339. Unlike a conventional VCSEL, the device further includes dielectric layer 321 and multi-layer spin-injector (for example, MgO/CoFeB/Ta 327/329/331)(for purposes of clarity, note that in the illustrated example, the three layers compose one spin-injector; each of the layers is not a spin-injector). It is worth noting that typical spin injectors generally include three layers: a crystalline barrier (such as the MgO 327); a ferromagnetic layer which provides the polarization (e.g., CoFeB 329 such as Co40Fe40B20 which has a strong intrinsic magnetic polarization); and a protective capping layer (such as tantalum 331), which can help determine the orientation of the magnetization out of plane (with regard to the injection interface) in combination with an annealing process. An annular spin injection region 399 is located close to the VCSEL active region 305 and is defined by an opening in the dielectric spacer 321. The structure of FIG. 4 thus shows a VCSEL with a ferromagnetic spin-injector contact on the bottom DBR 303. The annular spin-injector 399 is located around the VCSEL mesa, close to the VCSEL active medium 305, and separated from the VCSEL mesa by a thin dielectric spacer 321A.

Referring to FIG. 1B, in operation, the exemplary device 300 makes use of a true, physical randomness mechanism, as seen at 101. In particular, the ferromagnetic spin-injector in the annular contact region 399 is purposefully designed with a small energy barrier (Eb) compared to the ambient thermal energy (kT) such that Eb<<kT, where k is Boltzmann's constant, T is the absolute temperature, and kT is the thermal energy, as discussed above. Hence, the ambient thermal energy triggers a continuous and stochastic reversal of the magnetization orientation carried by the ferromagnetic spin-injector between UP and DOWN states. In operation, a voltage bias is applied across the VCSEL and electrons are injected from the annular bottom contact region 399 into the active medium 305. During the injection process, electrons go through the conductive spin-injector integrated on the conductive bottom DBR and are spin-polarized during transport through the spin-injector as seen at 393. The spin orientation of the injected electrons dominantly aligns with the magnetization orientation of the ferromagnetic spin-injector leading to a spin-polarized current. It follows that the spin-polarization of the current injected into the VCSEL active medium 305 will also stochastically switch between the two stable spin-UP and spin-DOWN states, mimicking the behavior of the spin-injector magnetization. Once the spin-polarized current reaches the VCSEL active medium 305, the spin information carried by the injected electrons is converted into circular polarization information carried by the emitted photons. This information transfer occurs through the optical quantum selection rules for dipole radiation associated with the conservation of angular momentum z-projections (m_{z}). Finally, since the spin-polarization of the injected electrons stochastically switches between the two stable spin-UP and spin-DOWN states, the polarization of photons emitted by the VCSEL will stochastically switch between LEFT- and RIGHT-circularly polarized, respectively, as seen at 391. It is worth noting that the non-linear amplification effects induced by the combination of the VCSEL's active medium and resonant optical cavity can provide an enhanced conversion efficiency of the injected spin-information into emitted light polarization information. Hence, a randomly oscillating output DoCP close to 100% can theoretically be achieved even by injection of an imperfectly spin-polarized current in the active medium of the laser (for example a current with an effective spin-polarization between 20% and 50%).

Still referring to FIG. 1B, the device is referred to as having a vertical cavity because the active medium (e.g., multiple QWs) is sandwiched between the bottom DBR and top DBR (i.e., there is a vertical orientation of the components) and because the LASER emission is perpendicular to the DBRs and active medium layer. When pumping is initiated, light begins oscillating and stimulated emission occurs between the mirrors and the active medium. Eventually, when the threshold is passed, light is emitted from the top. The device is referred to as being surface emitting because it emits through the top surface of the top DBR 307.

Referring to locations 393, before the carriers can reach the active medium, they pass through the spin polarizer so that they are spin-polarized once they reach the active medium. The physics of recombination dictate the type of polarization coming out of the laser. Consider view 101 and region 399. In one or more embodiments, the spin injector is monolithically integrated on the VCSEL structure with the spin injector layers directly on the laser. In one or more embodiments, the spin injector is specifically designed with a small energy barrier. Multilayer structures with different energy barriers can be designed using known techniques. Indeed, different spin injectors can be designed based on layering, material thickness, and material composition. The energy barrier determines how much energy needs to be supplied to the system for the magnetization to switch back and forth between stable states, for example left and right/down and up.

In typical magnetic memory designs, it is desirable for the energy barrier to be far in excess of the background thermal noise, to prevent the memory from changing state when a state change is not intended. In contrast, one or more embodiments deliberately design the injector with an energy barrier below the background thermal noise, to induce random changes of state. Thus, in one or more embodiments, the magnetization flips between up and down in a stochastic fashion based on the ambient thermal energy supplied to the system. As the carriers are injected, they will be stochastically spin polarized and will drift into the active medium, where they will begin to recombine. The light emission will thus stochastically vary from 100% left to 100% right polarization, correlated to the stochastic oscillation of the magnetization. Since the reversal of the magnetization is stochastic, the reversal of the light polarization is also stochastic, and the device is useful in a TRNG. In one or more embodiments the device is a two-terminal device and the input electrical signal is a DC voltage bias applied between contacts 333 and 343. A current is created from one electrode to the other, to push carriers (electrons) into the active region. The current can be visualized as a constant flow of electrons passing through the spin polarizer which “tells” the electrons to randomly go “up” or “down.”

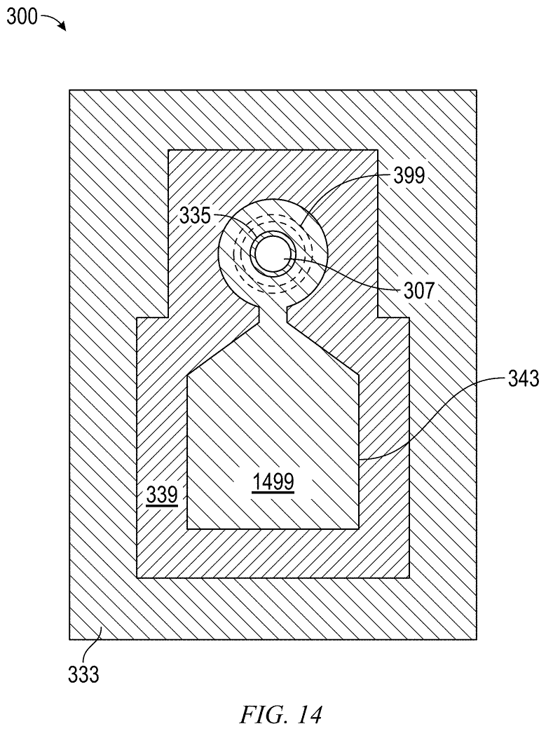

As best seen in the non-limiting example of FIG. 14, note the annular spin injector 399 around the VCSEL mesa close to the active region 305 (underneath 307, 335 in FIG. 14) (so that there is a small (e.g., 50-150 nm in typical semiconductor materials) distance for the drift). In one or more embodiments, the two electrodes 333, 343 are separated from each other by a dielectric spacer 339. Note that spin injector 399 is shown as generally annular in the examples. However, the VCSEL mesa is not necessarily circular so the spin injector 399 is not necessarily annular per se but more generally, in some cases, surrounds the periphery of the VCSEL mesa. Furthermore in this regard, a fully surrounding circular mesa/annular injector configuration is helpful for uniform carrier injection; however, this is non-limiting. Other embodiments could use a half circle, a point contact, etc. More generally, whatever is adjacent the bottom DBR 303 (e.g., Ti/Au 331) should have the spin injector 327, 329, 331 inserted in between. The contact can be circular, a semicircle, or even a single point. The spin injector 327, 329, 331 and contact 333 can be thought of as a single unit, which can have any shape as long as located close enough to the active medium 305. The top contact 335 does not include a spin injector but can also have any suitable shape such as a circle, semicircle, point, etc.

Advantageously, one or more embodiments make use of the above-discussed aspects of a spin-laser, wherein a population of electrons that are spin polarized are injected but only one type of polarization is seen at the output of the laser. That is, a spin polarizer randomly fluctuates with background thermal noise, and because of the amplification aspect of the laser, the output of the device switches between 100% left circularly polarized light and 100% right circularly polarized light.

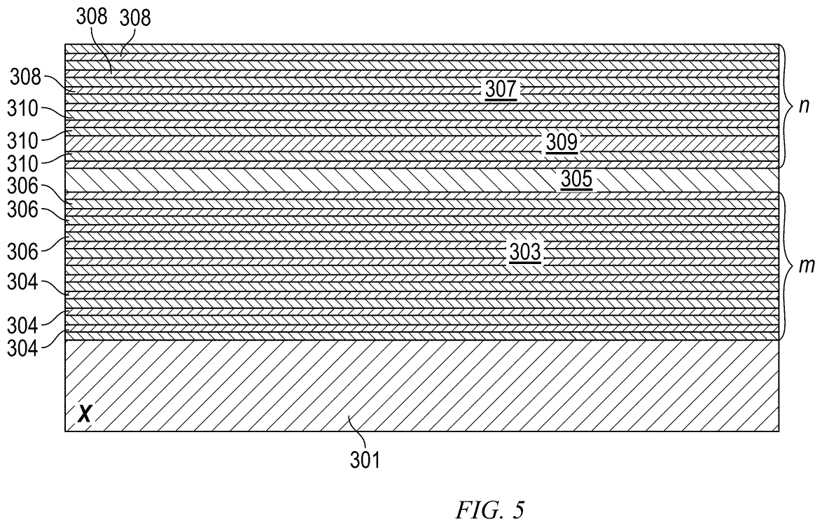

Consider now an exemplary process flow, beginning in FIG. 5; the figures associated with the process flow are cross-sections taken along line X in FIG. 3. FIG. 5 depicts VCSEL stack epitaxy (molecular-beam epitaxy (MBE) or metalorganic vapor-phase epitaxy (MOVPE), also known as organometallic vapor-phase epitaxy (OMVPE) or metalorganic chemical vapor deposition (MOCVD)). Consider, for illustrative purposes, a GaAs-based VCSEL with an emission at λ˜980 nm, it being understood that other architectures and/or different materials operating at different wavelengths are possible. Note the GaAs substrate 301, electrically conductive N-type bottom Distributed Bragg Reflector (DBR) 303 (essentially, a conductive semiconductor mirror), radiative active medium 305 including multiple quantum wells (QW) or quantum dots (QD), and electrically conductive P-type top DBR 307. Suitable N-type dopants for GaAs include substituting Te or S for As and substituting Sn, Si, or Ge for the Ga. Suitable P-type dopants for GaAs include substituting Si or Ge for As and substituting Zn or Cn for the Ga. DBR 303 includes m pairs of layers of N-doped GaAs 304 and AlAs 306, while DBR 307 includes n pairs of layers of P-doped GaAs 308 and AlAs 310. In general, the reflectance of the DBR stack increases with the number of periods. Typically, m>n; the reflectance of the bottom DBR 303 is typically greater than 99% while the reflectance of the top DBR 307 carrying out the light emission can be less than 99%; for example, 97% (since emission is desired from the top DBR, the top DBR should have lower reflectivity and fewer pairs of layers (n<m)). The active medium 305 can include, for example, 3-10 thin pairs of layers of InGaAs and GaAsP. The skilled artisan will appreciate that a quantum well is a nanometer-thin layer which can confine (quasi-)particles (typically electrons or holes) in the dimension perpendicular to the layer surface, whereas the movement in the other dimensions is not restricted. Note that the number of QWs can be changed depending on the output power desired. Typically, 3-10 QWs can be employed. The QW confines carriers in two dimensions in a known manner. The layer 309 is a thicker layer of GaAs used for formation of the aperture, as discussed further elsewhere herein.

Note that DBR 307 can be thought of as a non-limiting example of a top electrically conductive and optically reflective layer in which case 308, 309, 310 can be thought of as sub-layers; and DBR 303 can be thought of as a non-limiting example of a bottom electrically conductive and optically reflective layer in which case 304, 306 can be thought of as sub-layers.

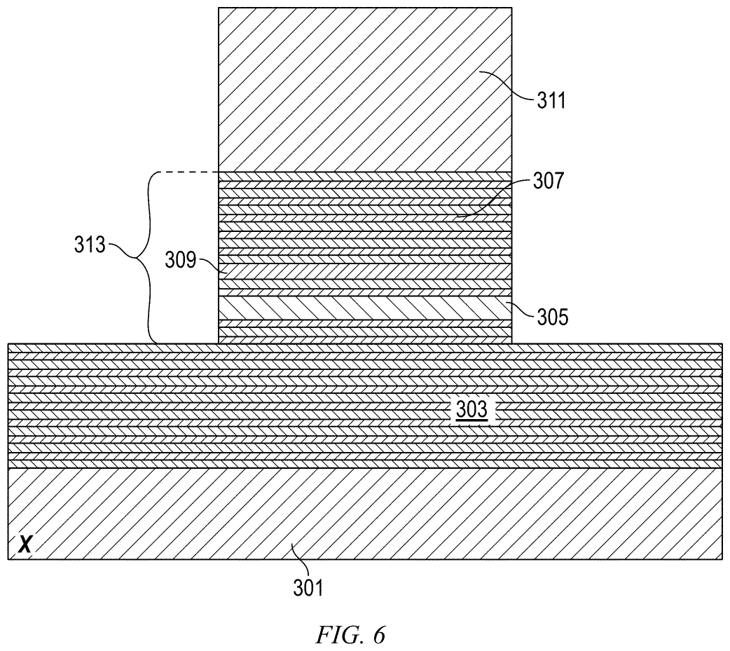

FIG. 6 shows mesa lithography and anisotropic etching. An organic planarization layer (OPL) 311 or hard mask is patterned to cover mesa regions 313 followed by an anisotropic etch of the top DBR 307 and active medium 305 down into the bottom DBR 303 (anisotropic etching removes the material on horizontal surfaces). The etching should proceed down into the bottom DBR slightly below the bottom of the active medium, to make room for the later deposition of the injector 327, 329, 331. Any suitable type of OPL/hard mask can be employed.

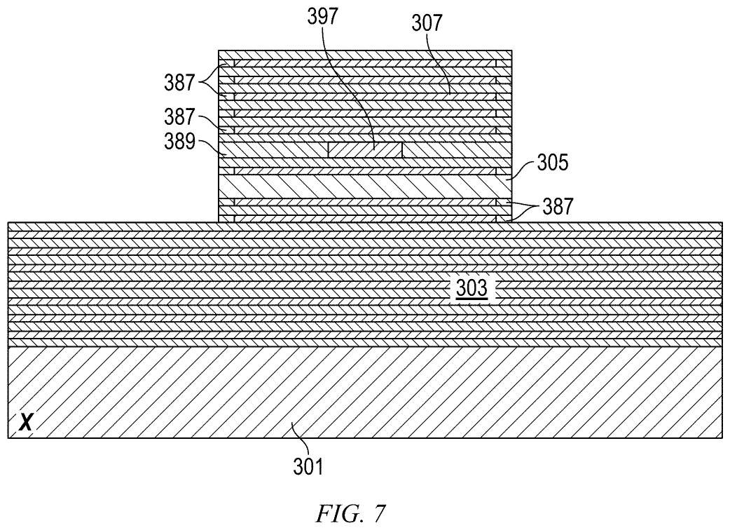

FIG. 7 shows aperture formation via selective wet oxidation. The aperture is typically used in optics to concentrate/focus the beam. In one or more embodiments, insert a thicker layer 309 (as seen in FIG. 6) of GaAs and run a selective oxidation of the GaAs 308 vs. AlAs 310 (as also seen in FIG. 7). The thicker layer 309 of GaAs will oxidize deeper (in a lateral direction) than the thinner layers 308. The skilled artisan will be able to control the dimensions and the oxidation process to achieve the desired aperture size. The small lateral oxidation penetration in the thin GaAs layers are a byproduct of the aperture formation (the oxidation advances more rapidly in the thick than in the thin GaAs layers). Note the significant lateral oxidation 389 within the thicker layer 309 forming the aperture 397, as well as the slight lateral oxidation 387 within the thinner layers.

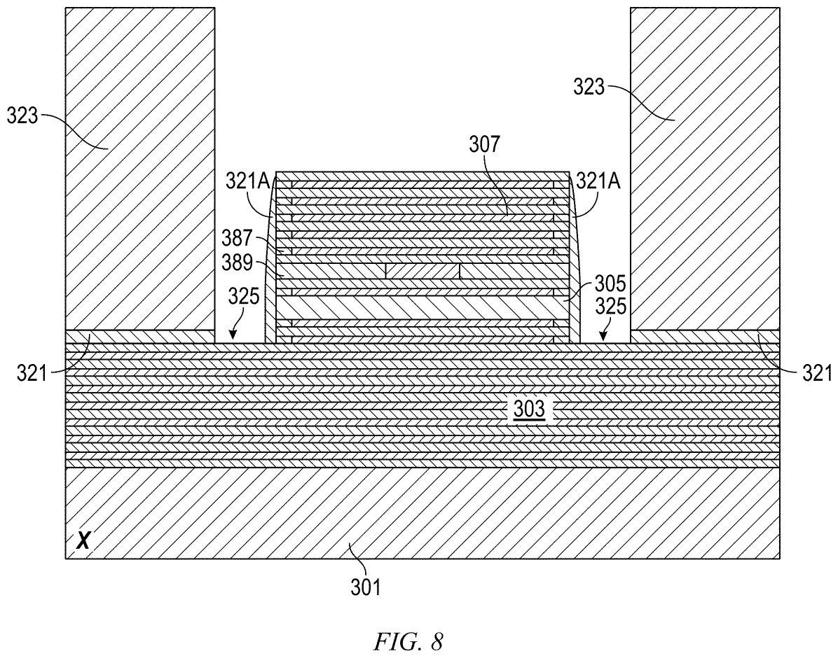

FIG. 8 shows the formation of the spin-injection contact region 325 and mesa sidewall spacer by sequential conformal dielectric deposition, OPL deposition, bottom contact lithography patterning, and anisotropic etching of the dielectric layer. In particular, deposit a suitable conformal dielectric layer (e.g., low-K) that can be selectively etched, such as SiBCN 321 (a non-limiting example), over the structure of FIG. 7; deposit an organic planarization layer (OPL) 323 over the SiBCN 321; pattern and etch the OPL in the spin-injection contact 325 and mesa regions; then perform an anisotropic etch (down but not sideways) to remove the SiBCN from the horizontal surfaces 325 and mesa regions. The portions of the SiBCN 321 remaining on the sides of the mesa after the anisotropic etch form sidewall spacers and are referred to as 321A (with thickness, e.g., 5-50 nm).

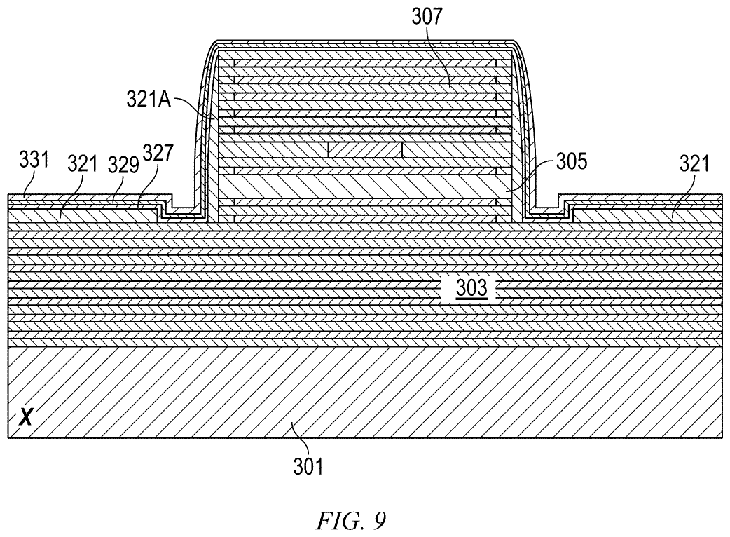

FIG. 9 shows the conformal deposition of a multi-layer ferromagnetic spin-injector (for example, MgO/CoFeB/Ta 327/329/331; the MgO is in contact with the semiconductors), and optionally, followed by a rapid thermal annealing (RTA) of the spin-injector layers. The MgO is typically deposited first (at the bottom); the CoFeB is typically deposited second (in the middle); and the Ta is typically deposited last (at the top). The ferromagnetic spin-injector is typically designed to exhibit Perpendicular Magnetic Anisotropy (PMA) and generates stable magnetization states oriented orthogonally to the spin-injection interface. In the case of the example in FIG. 9, the stable magnetization states are oriented in the vertical direction (UP or DOWN) which is aligned with the quantization axis of the quantum wells in the active medium. This allows fully leveraging the optical quantum selection rule in the radiative active medium governing the conservation of angular momentum for radiative transition. Hence, the injection and recombination of spin-UP electrons will trigger the emission of left-circularly polarized photons while the injection and recombination of spin-DOWN electrons will trigger the emission of right-circularly polarized photons.

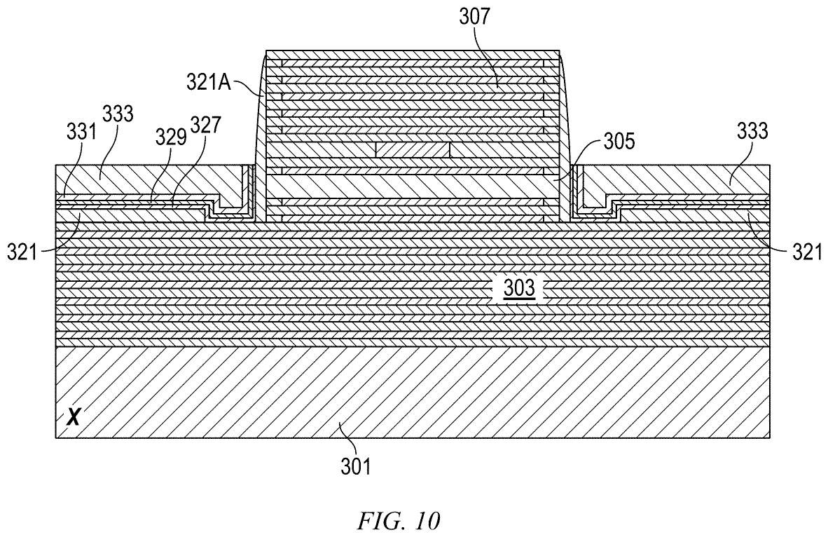

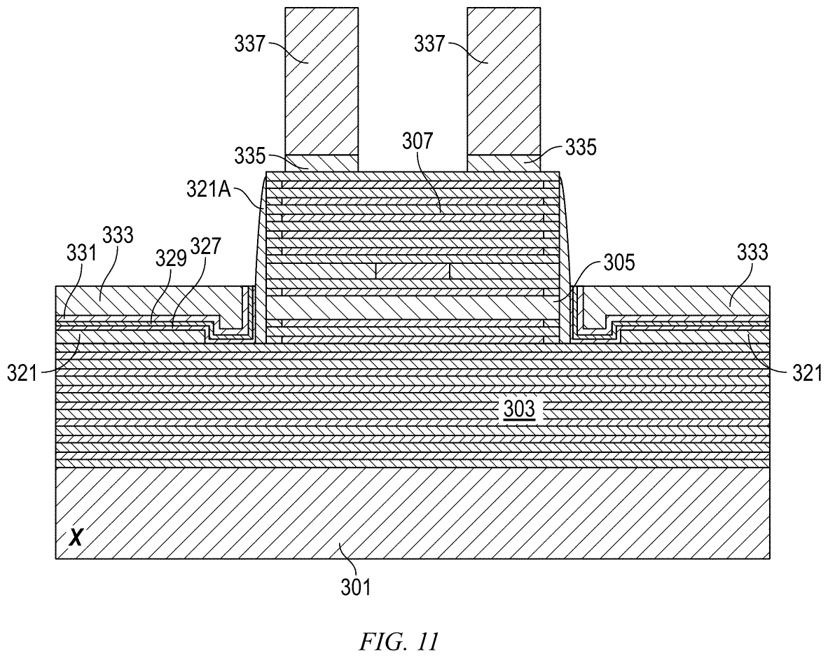

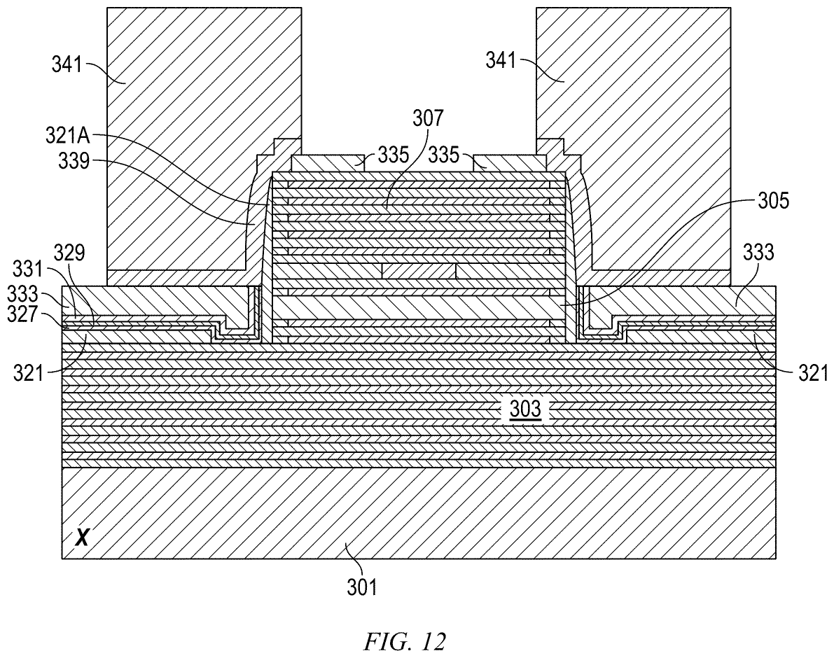

FIG. 10 illustrates the formation of the bottom contact 333 by depositing (e.g., Ti/Au) bottom contact material 333. The bottom contact material is recessed to the level shown in FIG. 10. The ferromagnetic spin-injector layers 327, 329, 331 are chamfered (compare to their extent in FIG. 9) and terminate at the upper surface of the material 333. In FIG. 11, deposit (e.g., Ti/Au) top contact material 335. Deposit an organic planarization layer (OPL) 337 over the top contact material 335 and pattern the OPL 337. Etch back the top contact material 335 (i.e., except for the portions remaining under the OPL 337 after the OPL 337 has been patterned). Remove the OPL 337. In FIG. 12, deposit a conformal dielectric (e.g., SiN 339) isolation layer over the structure of FIG. 11. Deposit an organic planarization layer (OPL) 341 over the conformal dielectric 339 and pattern the OPL 341. Anisotropically etch back the conformal dielectric 339 (i.e., except for the portions remaining under the OPL 341 after the OPL 341 has been patterned). Remove the OPL 341.

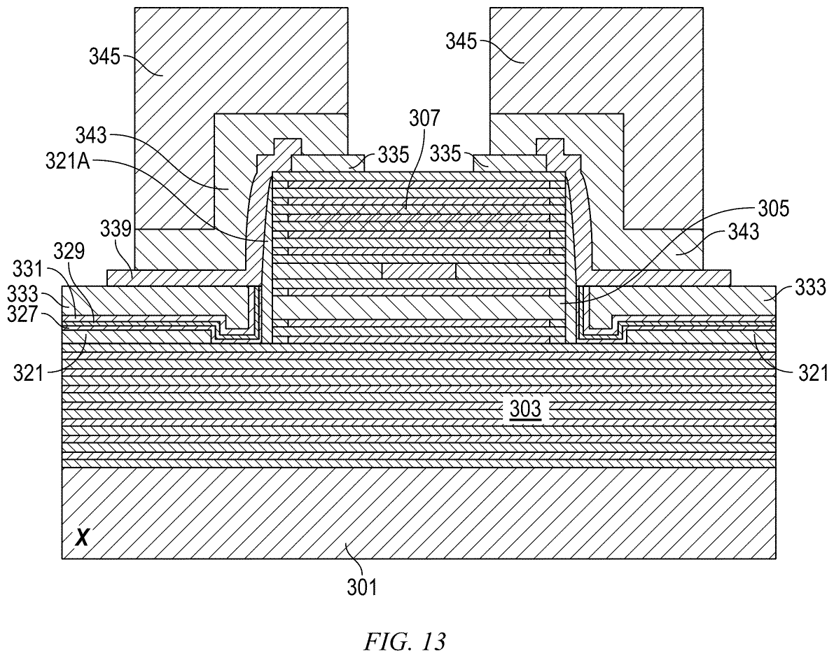

In FIG. 13, deposit top contact pad metal (e.g., Cu 343). Deposit an organic planarization layer (OPL) 345 over the top contact pad metal 343 and pattern the OPL 345. Etch back the top contact pad metal 343 (i.e., except for the portions remaining under the OPL 345 after the OPL 345 has been patterned). In FIG. 14, an enlarged top view of the final structure 300, note the bottom contact 333, contact isolation layer 339 (=conformal dielectric (e.g., SiN, SiO, Low-K material such as SiBVN, SiOC, SiOCN, and the like)), top contact pad metal 343, top contact material 335, and P-type top DBR 307. Note also the buried spin-injection region 399 shown in hidden lines. Layer 339 prevents the contacts from shorting. Note the wire bonding copper pad 1499.

It will thus be appreciated that an exemplary method for forming a spin-optronic TRNG includes forming a VCSEL epitaxy stack (as in FIG. 5); forming a VCSEL mesa (and optionally an oxide aperture (FIGS. 6 and 7)); forming a dielectric sidewall spacer around the mesa and defining the spin-injection contact region on the bottom electrically conductive DBR (FIG. 8); forming the ferromagnetic spin-injector and bottom metal contact on the bottom DBR (FIGS. 9 and 10); and forming the top metal contact on the top electrically conductive DBR (FIGS. 11-13).

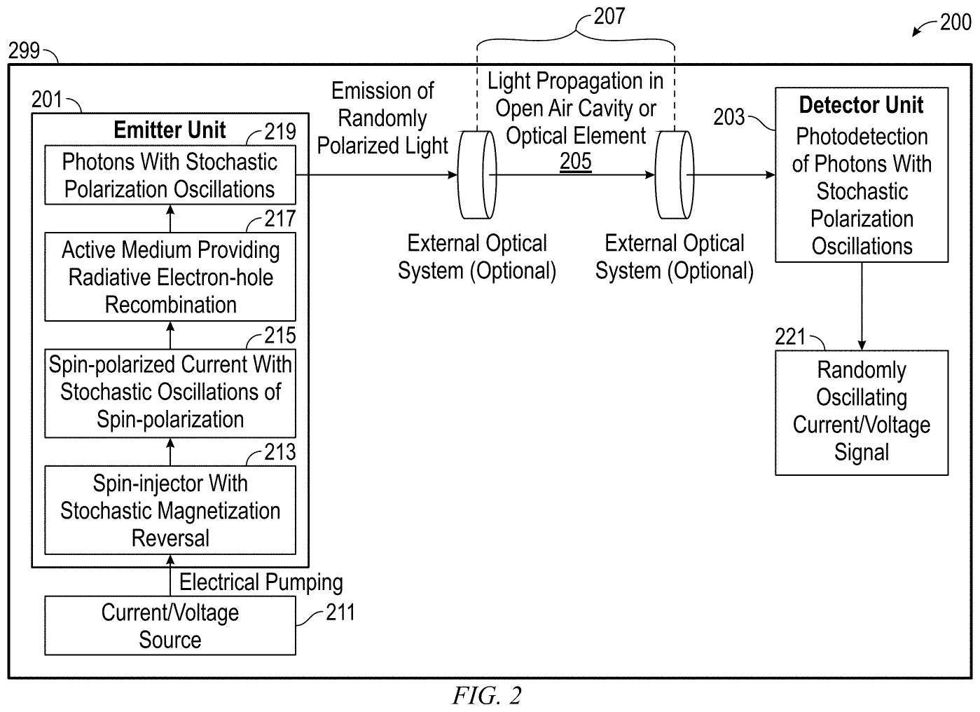

An optional step, when forming a complete system, is the formation of a polarization-sensitive photodetector 203 (FIG. 2) (polarization-sensitive photodetectors and their formation are familiar to the skilled artisan). Also, as noted, the oxide aperture is preferred but optional and devices can operate without such an aperture.

Furthermore, on a more detailed level, an exemplary method for forming a spin-optronic TRNG includes carrying out VCSEL stack epitaxy (FIG. 5), mesa lithography and anisotropic etch (FIG. 6), and selective wet oxidation (aperture formation) (FIG. 7). These steps can be carried out using standard VCSEL fabrication techniques.

Viewed at a high level of abstraction, additional steps include conformal dielectric deposition, bottom contact lithography, and anisotropic etch (as described with regard to FIG. 8); and conformal deposition of multi-layer spin-injectors with optional RTA of the spin-injector layers (FIG. 9). These steps can be carried out as described in greater detail elsewhere herein, for example.

Further steps include Ti/Au bottom contact deposition and Ti/Au metal recess (FIG. 10); top contact metal deposition, top contact lithography, and top contact metal etch back (FIG. 11); conformal dielectric deposition, contact isolation lithography, and dielectric etch back (FIG. 12); and top contact pad metal deposition, top contact pad lithography, and top contact pad metal etch back (FIG. 13). These steps can be carried out using standard VCSEL fabrication techniques.

In another aspect, referring to FIG. 2, an exemplary spin-optronic system 200 includes an emitter unit 201 generating random numbers encoded on light polarization, and a detector unit 203 converting the above randomly polarized optical signal into an electrical signal. The emitter unit and the detector unit are integrated within the same package 299, in one or more embodiments. The emitter unit and the detector unit are coupled to each other, as seen at 205, via an open air cavity (more generally, a vacuum or air, dry nitrogen, or any other suitable gas at any suitable pressure), or optionally by an optical element 207 such as an optical fiber. In one or more embodiments, the detector unit 203 is a photodetector that is sensitive to the polarization-state, and which converts the incoming optical signal into an outgoing electrical signal 221. The emitter unit and the detector unit can be integrated together, for example: within the same packaging substrate, within the same packaging unit from different substrates, vertically using wafer bonding techniques through heterogenous integration, or with other optical or electrical elements in the packaging unit.

The current/voltage source 211 can be connected, for example, between the contacts 333, 343, as discussed above. In a non-limiting example, the biasing voltage can range from 1-2 V, but the skilled artisan can select suitable biasing voltages inside or outside that range, as appropriate, depending on the materials employed. Spin injector 213 corresponds to region 399. The spin-polarized current 215 is visualized at 393 in FIG. 1. The active medium 217 corresponds to the QWs 305 (or QDs). The photons with stochastic polarization oscillations 219 are visualized at 391 in FIG. 1. The current, i.e., electrons, is driven through the ferromagnetic spin-injector to become spin-polarized before being injected in the QW or QD. Typically, the negative polarity of the voltage source is connected to the spin-injector contact. In the illustrated example: negative polarity connects to element 333 which is itself connected to the bottom N-type DBR (doped with electrons) which is best to minimize contact resistance on the electron injection side. The positive voltage polarity is connected to element 343, which connects to the P-type DBR where holes are injected.

It will be appreciated that one or more embodiments include a thin (e.g., 5-50 nm) dielectric spacer 321A separating the spin-injection region 399 from the active region 305, thus enabling the reduction/minimization of spin-depolarization. Furthermore, one or more embodiments include an annular spin-injection region 399 defined by the opening in the dielectric spacer 321.

It is worth noting that, based on the characteristic time needed for magnetization reversal (on the order of one nanosecond), one or more embodiments are capable of functioning at speeds up to, for example, 1-10 GHz.

Semiconductor device manufacturing includes various steps of device patterning processes. For example, the manufacturing of a semiconductor chip may start with, for example, a plurality of CAD (computer aided design) generated device patterns, which is then followed by effort to replicate these device patterns in a substrate. The replication process may involve the use of various exposing techniques and a variety of subtractive (etching) and/or additive (deposition) material processing procedures. For example, in a photolithographic process, a layer of photo-resist material may first be applied on top of a substrate, and then be exposed selectively according to a pre-determined device pattern or patterns. Portions of the photo-resist that are exposed to light or other ionizing radiation (e.g., ultraviolet, electron beams, X-rays, etc.) may experience some changes in their solubility to certain solutions. The photo-resist may then be developed in a developer solution, thereby removing the non-irradiated (in a negative resist) or irradiated (in a positive resist) portions of the resist layer, to create a photo-resist pattern or photo-mask. The photo-resist pattern or photo-mask may subsequently be copied or transferred to the substrate underneath the photo-resist pattern.

There are numerous techniques used by those skilled in the art to remove material at various stages of creating a semiconductor structure. As used herein, these processes are referred to generically as “etching.” For example, etching includes techniques of wet etching, dry etching, chemical oxide removal (COR) etching, and reactive ion etching (RIE), which are all known techniques to remove select material(s) when forming a semiconductor structure. The Standard Clean 1 (SC1) contains a strong base, typically ammonium hydroxide, and hydrogen peroxide. The SC2 contains a strong acid such as hydrochloric acid and hydrogen peroxide. The techniques and application of etching is well understood by those skilled in the art and, as such, a more detailed description of such processes is not presented herein.

Although the overall fabrication method and the structures formed thereby are novel, certain individual processing steps required to implement the method may utilize conventional semiconductor fabrication techniques and conventional semiconductor fabrication tooling. These techniques and tooling will already be familiar to one having ordinary skill in the relevant arts given the teachings herein. For example, the skilled artisan will be familiar with epitaxial growth and so on. Terms such as “high-K” and “low-K” have definite meanings to the skilled artisan and are not mere relative terms. Moreover, one or more of the processing steps and tooling used to fabricate semiconductor devices are also described in a number of readily available publications, including, for example: James D. Plummer et al., Silicon VLSI Technology: Fundamentals, Practice, and Modeling 1^{st} Edition, Prentice Hall, 2001 and P. H. Holloway et al., Handbook of Compound Semiconductors: Growth, Processing, Characterization, and Devices, Cambridge University Press, 2008, which are both hereby incorporated by reference herein. It is emphasized that while some individual processing steps are set forth herein, those steps are merely illustrative, and one skilled in the art may be familiar with several equally suitable alternatives that would be applicable.

It is to be appreciated that the various layers and/or regions shown in the accompanying figures may not be drawn to scale. Furthermore, one or more semiconductor layers of a type commonly used in such integrated circuit devices may not be explicitly shown in a given figure for ease of explanation. This does not imply that the semiconductor layer(s) not explicitly shown are omitted in the actual integrated circuit device.

Given the discussion thus far, and referring, for example, to FIG. 2, it will be appreciated that, in general terms, an exemplary system, according to an aspect of the invention, includes an emitter unit 201 that generates random numbers encoded in light polarization, and a detector unit 203 positioned (e.g. aligned with, connected by an optical element) with respect to the emitter unit. The detector unit receives the random numbers encoded in light polarization from the emitter unit and converts the random numbers encoded in light polarization into an electrical signal. In one or more embodiments, the emitter unit is configured to generate the random numbers as true random numbers corresponding to thermal noise. The emitter unit can include, for example, a vertical cavity surface emitting laser (VCSEL) or a vertical light emitting diode (VLED).

Referring to FIG. 4, in one or more embodiments, the emitter unit includes a substrate 301; a bottom electrically conductive and optically reflective layer (e.g., DBR 303) outward of the substrate; and an active medium layer (e.g., quantum well layer 305 or a quantum dot layer) outward of the bottom electrically conductive and optically reflective layer. The active medium layer is configured to convert spin information carried by injected spin-polarized electrical carriers into light polarization information carried by light emitted from radiative recombination of the electrical carriers. Also included is a top electrically conductive and optically reflective layer (e.g., DBR 307) outward of the active medium layer. The top electrically conductive and optically reflective layer optionally has an aperture 397 therein. The emitter unit further includes a bottom electrically conductive contact 333 electrically interconnected with the bottom electrically conductive and optically reflective layer and a top electrically conductive contact (e.g. 335 connected to 343) electrically interconnected with the top electrically conductive and optically reflective layer 307. The emitter unit still further includes an electrically conductive carrier spin-polarizer layer (e.g., 327, 329, 331) located between, and electrically interconnected with, the bottom electrically conductive and optically reflective layer and the bottom electrically conductive contact.

One or more embodiments of the system include a package 299 into which the emitter unit and the detector unit are integrated. In some cases, the package defines a gas or vacuum cavity (e.g., 205) coupling the emitter unit and the detector unit.

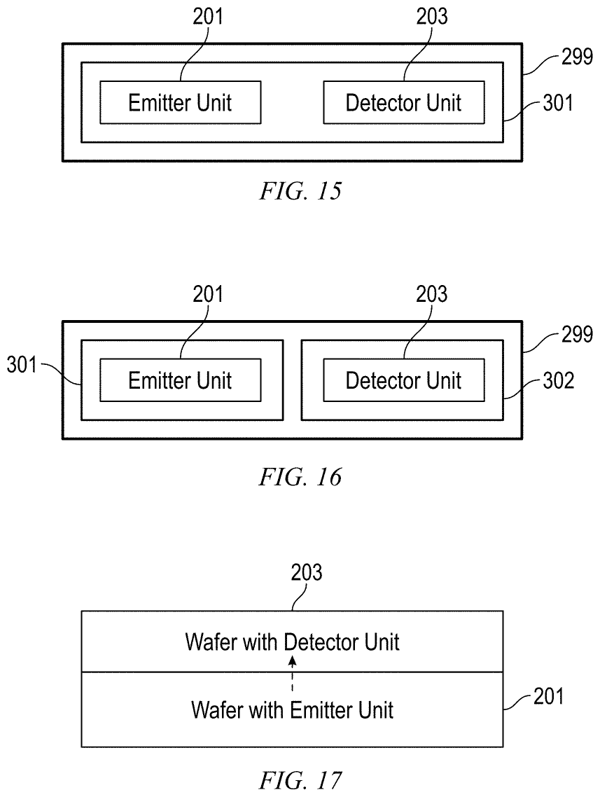

In some cases, as seen in FIG. 15, the detector unit 203 is located on the same substrate 301 as the emitter unit 201. On the other hand, in other cases, as seen in FIG. 16, the detector unit 203 is located on a detector unit substrate 302 than is different than the substrate 301 on which the emitter unit 201 is located.

In either of FIGS. 15 and 16, additional circuitry can be on the substrates 301, 302; for example, signal processing circuitry, the circuitry needing the generated random numbers, and so on.

One or more embodiments further include an optical element (e.g., 207) coupling the emitter unit and the collector unit.

In one or more embodiments, the bottom electrically conductive and optically reflective layer includes a bottom electrically conductive distributed Bragg reflector that is either n-type or p-type; the active medium layer includes a quantum well layer or a quantum dot layer; and the top electrically conductive and optically reflective layer includes a top electrically conductive distributed Bragg reflector of the other one of the n-type and the p-type (i.e., bottom is N top is P or bottom is P top is N). As noted, the top DBR optionally has an aperture therein. Furthermore, in one or more embodiments, the electrically conductive carrier spin-polarizer layer includes a magnetic tunnel junction, and the magnetic tunnel junction in turn includes an inmost tunnel barrier layer 327; a middle ferromagnetic layer 329; and an outer capping layer 331.

In some instances, the emitter unit further includes a dielectric layer 339 electrically isolating the top and bottom electrically conductive contacts, and a vertical dielectric 321A separating the bottom electrically conductive contact and the spin-polarizer layer from the active medium layer.

In one specific and non-limiting example, the electrically conductive carrier spin-polarizer layer includes an inmost magnesium oxide layer 327; a middle CoFeB (e.g., Co₄₀Fe₄₀B₂₀) layer 329; and an outmost tantalum layer 331. In a non-limiting example, the spin injection region 399 is annular when viewed in plan (see FIG. 14). The inmost magnesium oxide layer can have a thickness of from 2-3 nm and a (001) crystal orientation; the middle Co₄₀Fe₄₀B₂₀ layer can have a thickness of from 1-3 nm and a (001) crystal orientation; and the outmost tantalum layer can have a thickness of from 3-5 nm. In one or more such embodiments, the inmost magnesium oxide layer, the middle Co₄₀Fe₄₀B₂₀ layer, and the outmost tantalum layer extend beyond the annular spin-injection region when viewed in plan, and the emitter further includes a dielectric layer 321 separating the bottom contact, the inmost magnesium oxide layer, the middle Co₄₀Fe₄₀B₂₀ layer, and the outmost tantalum layer from the bottom distributed Bragg reflector beyond the annular spin-injection region when viewed in plan (outward of 399 under 333 in FIG. 14).

Referring to FIG. 17, optionally, the emitter unit 201 and detector unit 203 can be vertically integrated using wafer bonding techniques (e.g., direct bonding, as will be familiar to the skilled artisan) through heterogenous integration. One wafer has the emitter 201, the other has the detector 203, and the two wafers are bonded together. The light signal (symbolized by the dashed arrow) goes up between the wafers (the wafers could be reversed and the signal could go down as well).

Another aspect includes an apparatus (e.g., emitter such as spin-VCSEL (Vertical Cavity Surface Emitting Laser) device 300) as described above.

A further aspect includes a method (e.g., of fabrication); the method includes forming a vertical cavity surface emitting laser (VCSEL) epitaxy stack (see, e.g., FIG. 5). The epitaxy stack includes: a substrate 301; a bottom electrically conductive and optically reflective layer outward of the substrate (e.g., plurality of N-type bottom distributed Bragg reflector layer pairs (i.e., bottom DBR 303)); and an active medium layer (e.g., quantum well layer region 305) outward of the bottom electrically conductive and optically reflective layer. The active medium layer is configured to convert spin information carried by injected spin-polarized electrical carriers into light polarization information carried by light emitted from radiative recombination of the electrical carriers. The epitaxy stack further includes a top electrically conductive and optically reflective layer outward of the active medium layer (e.g., a plurality of P-type top distributed Bragg reflector layer pairs (i.e., top DBR 307)).

A further step (see, e.g., FIG. 6) includes forming a vertical cavity surface emitting laser (VCSEL) mesa in the top electrically conductive and optically reflective layer, the active medium layer, and a portion of the bottom electrically conductive and optically reflective layer. An even further step (see, e.g., FIG. 8) includes forming a dielectric spacer 321, 321A defining a spin-polarizer region (region 325) on the bottom electrically conductive and optically reflective layer. The spin-polarizer region is located adjacent the mesa when viewed in plan, as discussed elsewhere herein. Referring to FIGS. 9 and 10, an additional step includes forming an electrically conductive carrier spin-polarizer layer (e.g., 327, 329, 331) in the spin-polarizer region and forming a bottom electrically conductive contact 333, electrically interconnected with the bottom electrically conductive and optically reflective layer. The bottom electrically conductive contact is located adjacent the mesa when viewed in plan. Referring to FIGS. 11-13, another additional step includes forming a top electrically conductive contact (e.g., 335, 343) electrically interconnected with the top electrically conductive and optically reflective layer.

An optional further step (see, e.g., FIG. 7) includes forming an aperture 397 in a sub-layer 309 of the top electrically conductive and optically reflective layer within the mesa.

In some instances, the electrically conductive carrier spin-polarizer layer is a magnetic tunnel junction, and forming the electrically conductive carrier spin-polarizer layer includes depositing an inmost tunnel barrier layer 327, a middle ferromagnetic layer 329, and an outer capping layer 331.

Some embodiments further include carrying out rapid thermal annealing (RTA) of the inmost tunnel barrier layer, the middle ferromagnetic layer, and the outer capping layer.

In one specific but non-limiting example, forming the spin-polarizer layer includes depositing an inmost magnesium oxide layer 327, a middle CoFeB (e.g., Co₄₀Fe₄₀B₂₀) layer 329, and an outmost tantalum layer 331. In some instances, depositing the inmost magnesium oxide layer includes depositing the inmost magnesium oxide layer to a thickness of from 2-3 nm with a (001) crystal orientation; depositing the middle Co₄₀Fe₄₀B₂₀ layer includes depositing the middle Co₄₀Fe₄₀B₂₀ layer to a thickness of from 1-3 nm with a (001) crystal orientation; and depositing the outmost tantalum layer includes depositing the outmost tantalum layer to a thickness of from 3-5 nm.

Those skilled in the art will appreciate that the exemplary structures discussed above can be distributed in raw form (i.e., a single wafer having multiple unpackaged chips), as bare dies, in packaged form, or incorporated as parts of intermediate products or end products.

An integrated circuit in accordance with aspects of the present inventions can be employed in essentially any application and/or electronic system. Given the teachings of the present disclosure provided herein, one of ordinary skill in the art will be able to contemplate other implementations and applications of embodiments disclosed herein.

The illustrations of embodiments described herein are intended to provide a general understanding of the various embodiments, and they are not intended to serve as a complete description of all the elements and features of apparatus and systems that might make use of the circuits and techniques described herein. Many other embodiments will become apparent to those skilled in the art given the teachings herein; other embodiments are utilized and derived therefrom, such that structural and logical substitutions and changes can be made without departing from the scope of this disclosure. It should also be noted that, in some alternative implementations, some of the steps of the exemplary methods may occur out of the order noted in the figures. For example, two steps shown in succession may, in fact, be executed substantially concurrently, or certain steps may sometimes be executed in the reverse order, depending upon the functionality involved. The drawings are also merely representational and are not drawn to scale. Accordingly, the specification and drawings are to be regarded in an illustrative rather than a restrictive sense.

Embodiments are referred to herein, individually and/or collectively, by the term “embodiment” merely for convenience and without intending to limit the scope of this application to any single embodiment or inventive concept if more than one is, in fact, shown. Thus, although specific embodiments have been illustrated and described herein, it should be understood that an arrangement achieving the same purpose can be substituted for the specific embodiment(s) shown; that is, this disclosure is intended to cover any and all adaptations or variations of various embodiments. Combinations of the above embodiments, and other embodiments not specifically described herein, will become apparent to those of skill in the art given the teachings herein.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Terms such as “bottom”, “top”, “above”, “over”, “under” and “below” are used to indicate relative positioning of elements or structures to each other as opposed to relative elevation. If a layer of a structure is described herein as “over” another layer, it will be understood that there may or may not be intermediate elements or layers between the two specified layers. If a layer is described as “directly on” another layer, direct contact of the two layers is indicated. As the term is used herein and in the appended claims, “about” means within plus or minus ten percent.

The corresponding structures, materials, acts, and equivalents of any means or step-plus-function elements in the claims below are intended to include any structure, material, or act for performing the function in combination with other claimed elements as specifically claimed. The description of the various embodiments has been presented for purposes of illustration and description, but is not intended to be exhaustive or limited to the forms disclosed. Many modifications and variations will be apparent to those of ordinary skill in the art without departing from the scope and spirit thereof. The embodiments were chosen and described in order to best explain principles and practical applications, and to enable others of ordinary skill in the art to understand the various embodiments with various modifications as are suited to the particular use contemplated.

The abstract is provided to comply with 37 C.F.R. § 1.76(b), which requires an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the appended claims reflect, the claimed subject matter may lie in less than all features of a single embodiment. Thus, the following claims are hereby incorporated into the Detailed Description, with each claim standing on its own as separately claimed subject matter.

Given the teachings provided herein, one of ordinary skill in the art will be able to contemplate other implementations and applications of the techniques and disclosed embodiments. Although illustrative embodiments have been described herein with reference to the accompanying drawings, it is to be understood that illustrative embodiments are not limited to those precise embodiments, and that various other changes and modifications are made therein by one skilled in the art without departing from the scope of the appended claims.

What is claimed is:

1. A system comprising:
an emitter unit that generates random numbers encoded in light polarization; and
a detector unit positioned with respect to the emitter unit, wherein the detector unit receives the random numbers encoded in light polarization from the emitter unit and converts the random numbers encoded in light polarization into an electrical signal.

2. The system of claim 1, wherein the emitter unit is configured to generate the random numbers as true random numbers corresponding to thermal noise.

3. The system of claim 2, wherein the emitter unit comprises at least one of a vertical cavity surface emitting laser (VCSEL) and a vertical light emitting diode (VLED).

4. The system of claim 2, wherein the emitter unit comprises:
a substrate;
a bottom electrically conductive and optically reflective layer outward of the substrate;
an active medium layer, outward of the bottom electrically conductive and optically reflective layer, configured to convert spin information carried by injected spin-polarized electrical carriers into light polarization information carried by light emitted from radiative recombination of the electrical carriers;
a top electrically conductive and optically reflective layer outward of the active medium layer;
a bottom electrically conductive contact electrically interconnected with the bottom electrically conductive and optically reflective layer;
a top electrically conductive contact electrically interconnected with the top electrically conductive and optically reflective layer; and
an electrically conductive carrier spin-polarizer layer located between, and electrically interconnected with, the bottom electrically conductive and optically reflective layer and the bottom electrically conductive contact.

5. The system of claim 4, further comprising a package into which the emitter unit and the detector unit are integrated.

6. The system of claim 5, wherein the package defines a cavity including one of a gas and a vacuum region coupling the emitter unit and the detector unit.

7. The system of claim 5, wherein the detector unit is located on the substrate.

8. The system of claim 5, wherein the detector unit is located on a detector unit substrate different than the substrate of the emitter unit.

9. The system of claim 5, further comprising an optical element coupling the emitter unit and the collector unit.

10. The system of claim 4, wherein:
the bottom electrically conductive and optically reflective layer comprises a bottom electrically conductive distributed Bragg reflector of one of an n-type and a p-type;
the active medium layer comprises one of a quantum well layer and a quantum dot layer;
the top electrically conductive and optically reflective layer comprises a top electrically conductive distributed Bragg reflector of another one of the n-type and the p-type, and having an aperture therein; and
the electrically conductive carrier spin-polarizer layer comprises a magnetic tunnel junction, the magnetic tunnel junction comprising an inmost tunnel barrier layer; a middle ferromagnetic layer; and an outer capping layer.

11. The system of claim 10, further comprising:
a dielectric layer electrically isolating the top and bottom electrically conductive contacts; and
a vertical dielectric separating the bottom electrically conductive contact and the spin-polarizer layer from the active medium layer.

12. An apparatus comprising:
a substrate;
a bottom electrically conductive and optically reflective layer outward of the substrate;
an active medium layer, outward of the bottom electrically conductive and optically reflective layer, configured to convert spin information carried by injected spin-polarized electrical carriers into light polarization information carried by light emitted from radiative recombination of the electrical carriers;
a top electrically conductive and optically reflective layer outward of the active medium layer;
a bottom electrically conductive contact electrically interconnected with the bottom electrically conductive and optically reflective layer;
a top electrically conductive contact electrically interconnected with the top electrically conductive and optically reflective layer; and
an electrically conductive carrier spin-polarizer layer located between, and electrically interconnected with, the bottom electrically conductive and optically reflective layer and the bottom electrically conductive contact.

13. The apparatus of claim 12, wherein:
the bottom electrically conductive and optically reflective layer comprises a bottom electrically conductive distributed Bragg reflector of one of an n-type and a p-type;
the active medium layer comprises one of a quantum well layer and a quantum dot layer;
the top electrically conductive and optically reflective layer comprises a top electrically conductive distributed Bragg reflector of another one of the n-type and the p-type, and having an aperture therein; and
the electrically conductive carrier spin-polarizer layer comprises a magnetic tunnel junction, the magnetic tunnel junction comprising an inmost tunnel barrier layer; a middle ferromagnetic layer; and an outer capping layer.

14. The apparatus of claim 13, further comprising:
a dielectric layer electrically isolating the top and bottom electrically conductive contacts; and
a vertical dielectric separating the bottom electrically conductive contact and the spin-polarizer layer from the active medium layer.

15. The apparatus of claim 13, wherein:
the inmost tunnel barrier layer comprises magnesium oxide;
the middle ferromagnetic layer comprises CoFeB; and
the outer capping layer comprises tantalum.

16. The apparatus of claim 13, wherein the spin-polarizer layer is annular when viewed in plan.

17. A method, comprising:
forming a vertical cavity surface emitting laser (VCSEL) epitaxy stack, the epitaxy stack including:
a substrate;
a bottom electrically conductive and optically reflective layer outward of the substrate;
an active medium layer, outward of the bottom electrically conductive and optically reflective layer, configured to convert spin information carried by injected spin-polarized electrical carriers into light polarization information carried by light emitted from radiative recombination of the electrical carriers; and
a top electrically conductive and optically reflective layer outward of the active medium layer;
forming a vertical cavity surface emitting laser (VCSEL) mesa in the top electrically conductive and optically reflective layer, the active medium layer, and a portion of the bottom electrically conductive and optically reflective layer;
forming a dielectric spacer defining a spin-polarizer region on the bottom electrically conductive and optically reflective layer, the spin-polarizer region being located adjacent the mesa when viewed in plan;
forming an electrically conductive carrier spin-polarizer layer in the spin-polarizer region and forming a bottom electrically conductive contact, electrically interconnected with the bottom electrically conductive and optically reflective layer, the bottom electrically conductive contact being located adjacent the mesa when viewed in plan; and
forming a top electrically conductive contact electrically interconnected with the top electrically conductive and optically reflective layer.

18. The method of claim 17, further comprising forming an aperture in a sub-layer of the top electrically conductive and optically reflective layer within the mesa.

19. The method of claim 18, wherein the electrically conductive carrier spin-polarizer layer comprises a magnetic tunnel junction, and wherein forming the electrically conductive carrier spin-polarizer layer comprises depositing an inmost tunnel barrier layer, a middle ferromagnetic layer, and an outer capping layer.

20. The method of claim 19, further comprising carrying out rapid thermal annealing (RTA) of the inmost tunnel barrier layer, the middle ferromagnetic layer, and the outer capping layer.
